(19) United States
(12) Patent Application Publication
(10) Pub. No.: US 2003/0162564 A1
(43) Pub. Date: Aug. 28, 2003

(54) Portable telephone with image sensing unit, and method of controlling same

(75) Inventors: Soichiro Kimura, Asaka-shi (JP); Naoyuki Nishino, Asaka-shi (JP); Hiroyuki Uchiyama, Asaka-shi (JP); Takaaki Kotani, Fuchu-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/358,172

(22) Filed: Feb. 5, 2003

(30) Foreign Application Priority Data
Feb. 13, 2002 (JP) 2002-35257
Sep. 27, 2002 (JP) 2002-282098

(51) Int. Cl. H04M 1/00

(52) U.S. Cl. 455/556; 455/550

(57) ABSTRACT

The peripheral surface of columnar rotary body is formed to have a light-entrant opening, and the bottom of the rotary body is formed to have an emergent-light opening. Light that has entered from the light-entrant opening is introduced to the emergent-light opening by a first mirror. Light that has impinged upon the rotary body is introduced from the emergent-light opening to a first half body that constructs the main unit of a portable telephone. A second mirror is disposed within the first half body, and light that has emerged from the rotary body is introduced to the photoreceptor surface of a C-MOS sensor by the second mirror. Since the rotary body and the first half body are not connected by a cord or the like, the rotary body can be turned through any angle to enable imaging at any angle.

### BACKGROUND OF THE INVENTION

1.Field of the Invention

This invention relates to a portable telephone [inclusive of a PHS (Personal Handyphone System) portable telephone] equipped with an image sensing unit, the image sensing unit per se, a digital camera, methods of controlling the same, and a columnar body with which the image sensing unit is fitted.

2.Description of the Related Art

The provision of portable telephones with multiple functions has been accompanied by the commercialization of portable telephones equipped with an image sensing unit such as a digital still camera. An image represented by image data obtained as a result of imaging performed by the digital still camera is displayed on a display screen of a display unit provided on the portable telephone. The image data obtained by such imaging is also transmitted to another portable telephone. When the image data is received by the other portable telephone, the image represented by the received image data is displayed on the display screen of the display unit belonging to the other portable telephone.

The display screen of the display unit usually is provided on the inner side of the portable telephone. The imaging direction points outwardly of the portable telephone so that the imaging angle can be checked by the user. This means that one cannot image oneself while viewing one's own image on the display screen. In one contemplated arrangement, the image sensing unit is made rotatable through 180° so that one may image oneself while viewing one's own image on the display screen. However, since it is necessary for the image sensing unit and the portable telephone proper to be connected by a cord, the image sensing unit is not rotatable freely and the image sensing direction therefore cannot be set freely to any angle between 0 and 360°.

For example, a portable electronic device described in the specification of Japanese Patent Application Laid-Open No. 11-331658 is equipped with a main unit and a cylindrical case. The upper part of the cylindrical case is provided with a mirror by which light representing the image of a subject is guided to an optoelectronic transducer disposed within the case. Since the optoelectronic transducer is placed inside the case, however, the transducer rotates when the case is rotated. Because the cord of the optoelectronic transducer is connected to the main unit, rotation of the case is limited by the cord.

An optical image recording apparatus described in the specification of Japanese Patent Application Laid-Open No. 2000-515255 has a body that accommodates an image recording device. Though the optical path of light that impinges upon the image recording device can be deflected, absolutely no consideration is given to rotation of the body.

### SUMMARY OF THE INVENTION

Accordingly, an object of the present invention is to so arrange it that the image direction can be set freely to any angle between 0 and 360°.

According to a first aspect of the present invention, the foregoing object is attained by providing a portable telephone equipped with an image sensing unit and having a portable telephone main unit and a columnar body. The columnar body has a hollow interior, a side face formed to include an entrant-light opening for introducing light and a bottom face formed to include an emergent-light opening for emitting light, and is freely rotatable with respect to the portable telephone main unit. Disposed within the columnar body is a first deflector for guiding light, which has entered from the entrant-light opening, to the emergent-light opening. The portable telephone main unit has a solid-state electronic image sensing device disposed at a position, which is independent of the columnar body, on an optical path of emergent light from the emergent-light opening for outputting a video signal representing the image of a subject that has been formed on a photoreceptor surface, and a transmitting circuit for transmitting the video signal, which has been output from the solid-state electronic image sensing device, to a telephone network.

The first aspect of the present invention provides also a method of controlling the above-described portable telephone equipped with the image sensing unit. Specifically, the present invention according to the first aspect thereof provides a method of controlling a portable telephone equipped with an image sensing unit and having a portable telephone main unit and a columnar body, the columnar body being freely rotatable with respect to the portable telephone main unit and having a hollow interior, a side face formed to include an entrant-light opening for introducing light and a bottom face formed to include an emergent-light opening for emitting light, the method comprising the steps of: guiding light, which has entered from the entrant-light opening, to the emergent-light opening; disposing a solid-state electronic image sensing device at a position, which is independent of the columnar body, on an optical path of emergent light from the emergent-light opening; outputting a video signal representing the image of a subject that has been formed on a photoreceptor surface; and transmitting the video signal, which has been output from the solid-state electronic image sensing device, to a telephone network.

The axial direction of the columnar body and the longitudinal direction of the portable telephone main unit may be the same or may be arranged so as to intersect each other at an angle of 90°.

In accordance with the present invention, the solid-state image sensing device is not provided inside the columnar body but is instead provided in the portable telephone main unit at a position that is independent of the columnar body. Even when the columnar body is turned, therefore, it will not be obstructed by the output cord of the solid-state image sensing device. Light that has entered from the entrant-light opening exits from the emergent-light opening so that a light image representing the image of a subject is formed on the photoreceptor surface of the solid-state image sensing device. Even if the columnar body is turned in excess of 360°, therefore, the image of the subject will be formed on the photoreceptor surface of the solid-state image sensing device. The imaging direction can be set to any angle between 0 and 360°.

The columnar body may be constructed independently.

Preferably, the solid-state image sensing device is placed so as to lie parallel to a surface of the portable telephone on the inner side thereof. In such case a second deflector for guiding the emergent light to the photoreceptor surface of the solid-state image sensing device is provided within the portable telephone main unit.

The portable telephone can be reduced in thickness.

The portable telephone main unit may be further provided with a detector for detecting angle of rotation of the columnar body; a display unit for displaying the image of a subject, which is represented by a video signal output from the solid-state image sensing device, on a display screen; and a display controller for controlling the display unit, in accordance with the angle detected by the detector, in such a manner that the image of the subject to be displayed will be displayed as an erect image.

Thus, an erect image is displayed on the display screen regardless of the angle to which the columnar body is turned. An image that is easy to view, therefore, is displayed.

According to a second aspect of the present invention, the foregoing object is attained by providing an image sensing unit comprising an image sensing unit main body and a columnar body. The columnar body has a hollow interior, a side face formed to include an entrant-light opening for introducing light and a bottom face formed to include an emergent-light opening for emitting light, and is freely rotatable with respect to the portable telephone main unit, with a first deflector for guiding light, which has entered from the entrant-light opening, to the emergent-light opening being disposed within the columnar body. The image sensing unit main body has a solid-state image sensing device disposed at a position, which is independent of the columnar body, on an optical path of emergent light from the emergent-light opening for outputting a video signal representing the image of a subject that has been formed on a photoreceptor surface.

The second aspect of the present invention provides also a method of controlling the above-described image sensing unit. Specifically, the present invention according to the second aspect thereof provides a method of controlling an image sensing unit having an image sensing unit main unit and a columnar body, the columnar body being freely rotatable with respect to the portable image sensing device main unit and having a hollow interior, a side face formed to include an entrant-light opening for introducing light and a bottom face formed to include an emergent-light opening for emitting light, the method comprising the steps of: guiding light, which has entered from the entrant-light opening, to the emergent-light opening; disposing a solid-state electronic image sensing device at a position, independent of the columnar body, on an optical path of emergent light from the emergent-light opening; and outputting a video signal representing the image of a subject that has been formed on a photoreceptor surface.

A digital camera can be constructed by recording the video signal, which is output from the solid-state image sensing device, on a recording medium in the above-described image sensing unit.

The image direction can be set freely to any angle between 0 and 360° in the image sensing unit and in the digital camera.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1a and FIG. 1b are perspective views of a portable telephone according to the present invention;

FIG. 2 is a sectional view taken along line II-II of FIG. 1a;

FIG. 3 is a plan view of the portable telephone;

FIG. 4a is a side view of the portable telephone and FIG. 4b a diagram illustrating the relationship between a subject and the image of the subject;

FIG. 5a is a side view of the portable telephone and FIG. 5b a diagram illustrating the relationship between a subject and the image of the subject;

FIG. 6a is a side view of the portable telephone and FIG. 6b a diagram illustrating the relationship between a subject and the image of the subject;

FIG. 7 is a plan view of the portable telephone from which a rotating body has been removed;

FIG. 8 is a diagram illustrating metal terminals;

FIG. 9 is a bottom view of the rotating body;

FIG. 10 is a block diagram illustrating the electrical structure of the portable telephone;

FIG. 11 is a flowchart illustrating processing in an imaging mode;

FIG. 12 is a partially cut-away sectional view;

FIG. 13 is a sectional view illustrating a zoom lens mechanism in a wide-angle state according to the present invention;

FIG. 14 is a sectional view illustrating the zoom lens mechanism in a telephoto state according to the present invention; and

FIG. 15 is an exploded perspective view of the zoom lens mechanism according to the present invention.

### DESCRIPTION OF THE PREFERRED EMBODIMENT

A preferred embodiment of the present invention will now be described with reference to the accompanying drawings.

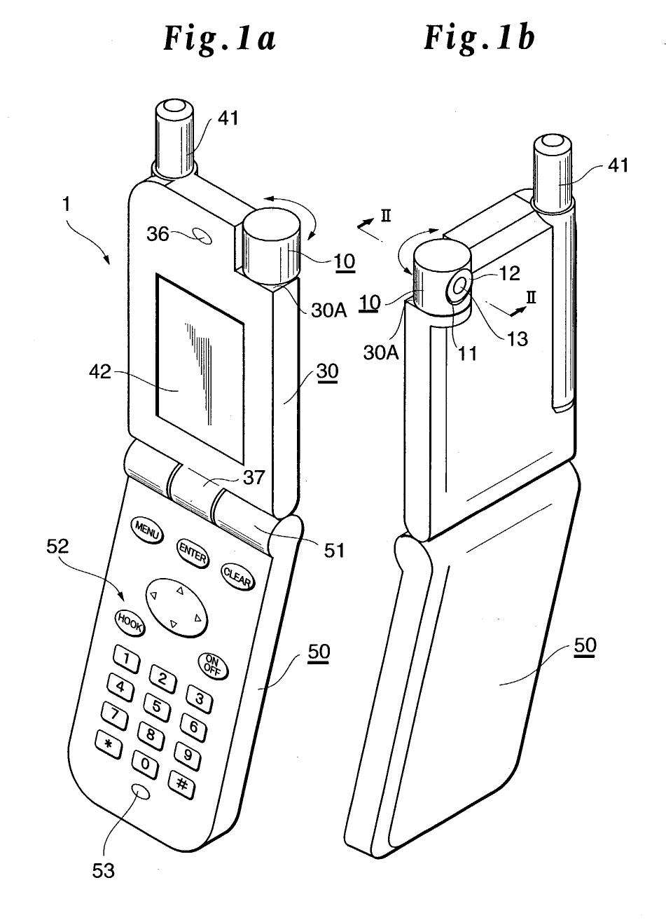

FIGS. 1a and 1b, which illustrate a preferred embodiment of the present invention, are perspective views of a portable telephone 1 equipped with a digital camera. The portable telephone 1 shown in FIGS. 1a and 1b is of the foldable type. FIG. 1a is a perspective view in which the portable telephone 1, in the opened state, is shown from the front, and FIG. 1b is a perspective view in which the portable telephone 1, in the opened state, is shown from the back.

The portable telephone 1 has a first half body 30 and a second half body 50.

The lower part of the first half body 30 is formed to include a bearing tube 37 through the interior of which a shaft is passed. The upper part of the second half body 50 is formed to include a bearing tube 51 through the interior of which the aforementioned shaft is passed. The first half body 30 and second half body 50 are joined together in a freely foldable manner by passing the shaft (not shown) through the bearing tubes 37, 51.

The surface on the inner side of the first half body 30 is formed to have a display screen 42 over substantially the entire area thereof. A telephone-receiver opening 36 within which a speaker has been placed is formed above the display screen 42.

The upper right-hand portion of the first half body 30 is formed to have a cut-out 30A. Provided in the cut-out 30A is a rotary body (columnar body) 10 having an axis of rotation along a direction identical with the longitudinal direction of the first half body 30. The imaging optical system of a digital camera is provided inside the rotary body 10, which is free to rotate through an angle in excess of 360°.

The top of the first half body 30 is provided with an antenna 41 on the left side thereof.

The surface on the inner side of the second half body 50 is formed to have a keypad 52 that includes numeric keys. The lower part of the second half body 50 is provided with a telephone-transmitter opening 53 in which a microphone has been placed.

As shown in FIG. 1b, the side surface of the rotary body 10 is formed to have a light-entrant opening 11 upon which light representing the image of a subject impinges. A lens barrier 12 that is open at its center is secured in the light-entrant opening 11. A lens 13 is exposed at the central opening of the lens barrier 12.

The user holds the second half body 50, operates the keypad 52 and enjoys the image displayed on the display screen 42. When a subject is imaged, the rotary body 10 is turned by the user's fingers so as to point the light-entrant opening 11 of the rotary body 10 in the direction of the subject imaged.

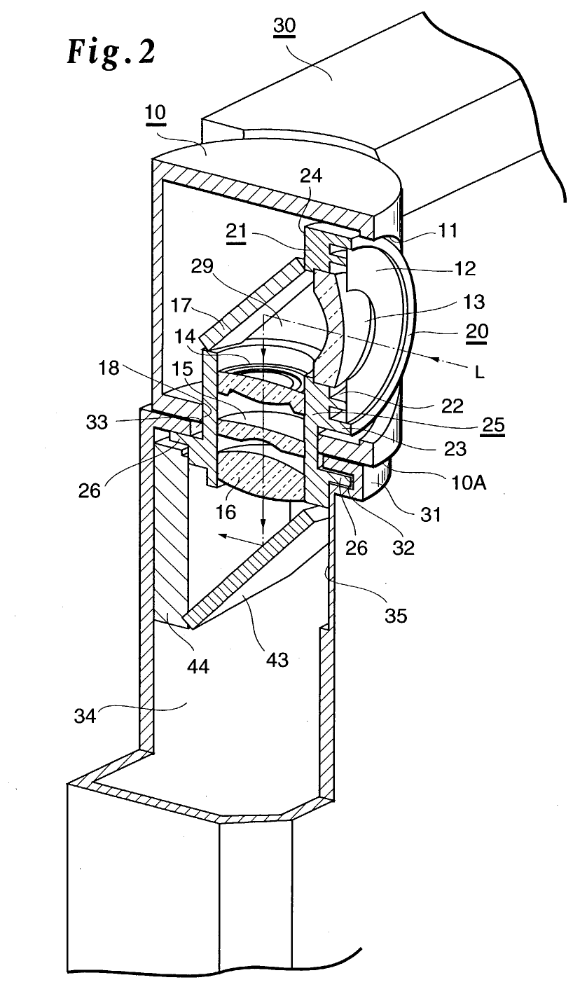

FIG. 2 is a sectional view taken along line II-II of FIG. 1b.

The peripheral surface of the rotary body 10 is formed to have the circular light-entrant opening 11, as mentioned above. The bottom of the rotary body 10 is formed to have a circular emergent-light opening 18.

The interior of the rotary body 10 is provided with a lens holder 20. The lens holder 20 has a first tubular portion 21 and a second tubular portion 25, the former having a height smaller than that of the latter. The central axis of the first tubular portion 21 and the central axis of the second tubular portion 25 intersect each other at an angle of 90°. The outer circumference of the first tubular portion 21 and the inner circumference of the light-entrant opening 11 in rotary body 10 substantially agree, and the first tubular portion 21 is fitted into the light-entrant opening 11. The outer circumference of the second tubular portion 25 and the inner circumference of the emergent-light opening 18 in rotary body 10 substantially agree, and the second tubular portion 25 is fitted into the emergent-light opening 18. The first tubular portion 21 fixes a lens barrier 12 the central portion of which is open, and a lens 13. The second tubular portion 25 fixes three lenses 14, 15 and 16.

The first tubular portion 21 of the lens holder 20 is formed to include a first lens barrier holding wall 23 having a surface identical with that of the outer peripheral surface of the first tubular portion 21, and a second lens barrier holding wall 22 whose height is less than that of the first lens barrier holding wall 23. The outer peripheral surface of the lens barrier 12 is secured to the inner wall of the first lens barrier holding wall 23, and the surface on the inner side of the lens barrier 12 is fixed to the top surface of the second lens barrier holding wall 22. The lens 13 is secured to the inner peripheral surface of the first tubular portion 21.

The lenses 14, 15 and 16 are fixed at prescribed intervals in the inner peripheral surface of the second tubular portion 25 of lens holder 20. Further, the lower end of the second tubular portion 25 of lens holder 20 is formed to have an outwardly protruding vane 26.

Bridging and secured to the upper part of a lower end face 24 of the first tubular portion 21 and the left-hand part an upper end face 29 of the second tubular portion 25 is a first mirror (first deflector) 17. The angle of the first mirror 17 is decided in such a manner that light L that has entered from the light-entrant opening 11 of the rotary body 10 will be deflected by 90° so as to emerge from the emergent-light opening 18.

The top side of the cut-out 30A of first half body 30 is formed to have an opening 33 at a position corresponding to the emergent-light opening 18 of rotary body 10 and of a size corresponding to the size of the emergent-light opening 18. The upper part of the cut-out 30A is formed to include an outwardly protruding recess portion 31 for holding the rotary body. A recess 32 is formed in the holding recess portion 31. An inner wall 34 inside the first half body 30 forms a small gap with the top side of the cut-out 30A for receiving and securing a C-MOS sensor 44 the photoreceptor surface of which is inwardly directed.

Part of the vane 26 formed on the second tubular portion 25 described above fits into the recess 32 of the holding recess portion 31, and part of the vane 26 fits into a gap between the C-MOS sensor 44 and the top side of the first half body 30, whereby the second tubular portion 25, namely the rotary body 10, is positioned. The rotary body 10 can be rotated about an axis the direction of which is identical with that of the longitudinal axis of the first half body 30.

A second mirror (second deflector) 43 bridges and is secured to an inner wall 35 on the outer side of the first half body 30 and the lower end of the C-MOS sensor 44 within the first half body 30. The angle of the second mirror 43 is decided in such a manner that light that has exited the emergent-light opening 18 of rotary body 10 will be deflected toward the C-MOS sensor 44.

The light L that has entered from the light-entrant opening 11 of rotary body 10 is condensed by the lens 13 and deflected downwardly by the first mirror 17. The deflected light is guided to the photoreceptor surface of the C-MOS sensor 44 by the second mirror 43 via the lenses 14, 15 and 16. The image of the subject is formed on the photoreceptor surface of the C-MOS sensor 44.

It should be noted that the C-MOS sensor 44 resides within the first half body 30 and not in the interior of the rotary body 10. Even if the rotary body 10 is rotated in excess of 360°, the rotation of the rotary body 10 will not be impeded by a cord connected to the C-MOS sensor 44.

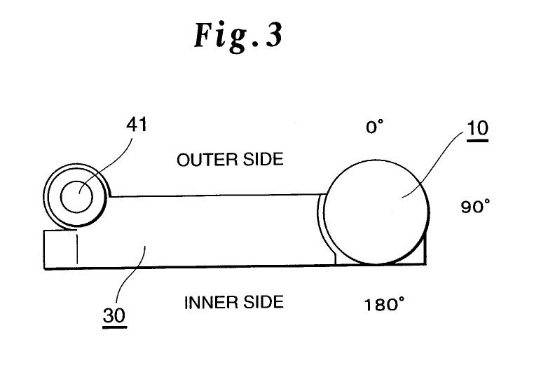

FIG. 3 is a plan view showing the portable telephone 1 in the opened state.

According to this embodiment, the rotary body 10 can be rotated in excess of 360°, as mentioned above. Let the angle of rotation be 0° when the light-entrant opening 11 of the rotary body 10 is pointing to the outside of the portable telephone 1, as shown in FIG. 1b, 90° when the light-entrant opening 11 has been rotated 90° clockwise from the angle of 0° as viewed from the plane of the drawing, and 180° when the light-entrant opening 11 has been rotated a further 90° clockwise from the angle of 90° as viewed in the plane of the drawing, so that the light-entrant opening 11 of rotary body 10 points inwardly of the portable telephone 1.

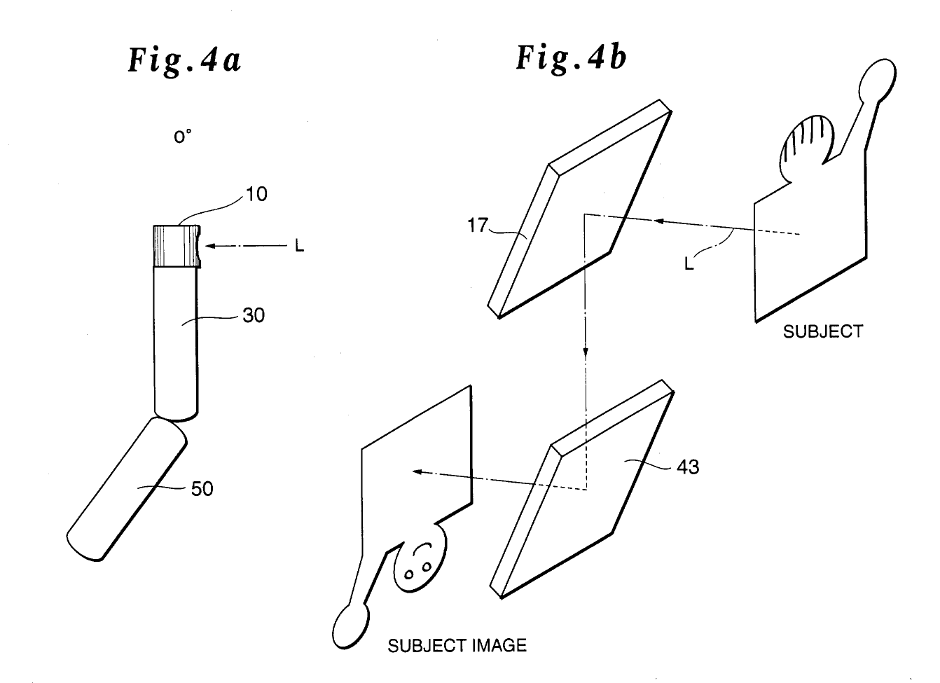

FIGS. 4a and 4b to FIGS. 6a and 6b illustrate the relationship between the angle of rotation of rotary body 10 and the image of a subject. The “a” drawings illustrate the relationship between the entrant light L and the rotary body 10, and the “b” drawings illustrate the relationship between the subject and the image of the subject. The lenses 13, 14, 15 and 16 are not shown in FIGS. 4b, 5b and 6b.

FIGS. 4a and 4b illustrate a case where the angle of rotation of the rotary body 10 is 0°.

In a case where the angle of rotation is 0°, the image of an erect subject is inverted owing to image formation by the lenses 13, 14, 15 and 16, reflection by the first mirror 17 and reflection by the second mirror 43. In this embodiment, read-out of a video signal from the C-MOS sensor 44 is controlled so as to erect the image represented by the video signal output from the C-MOS sensor 44 when the inverted image is formed on the photoreceptor surface of the C-MOS sensor 44.

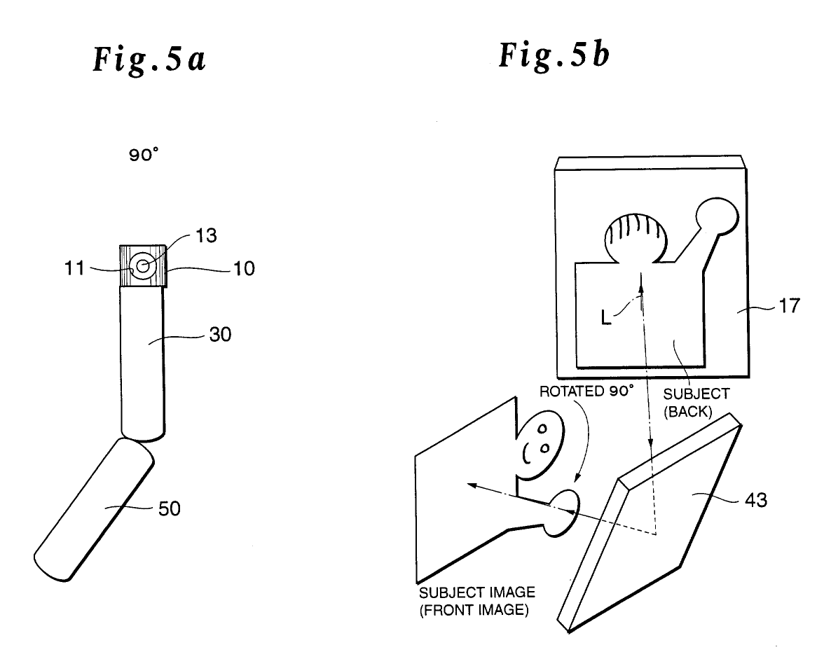

FIGS. 5a and 5b illustrate a case where the angle of rotation of the rotary body 10 is 90°. The back of the subject appears in FIG. 5b.

In a case where the angle of rotation is 90°, the image of an erect subject is that obtained by rotating the subject 90° in the clockwise direction owing to image formation by the lenses 13, 14, 15 and 16, reflection by the first mirror 17 and reflection by the second mirror 43. For this reason, image rotation processing is executed so as to rotate the image, which is represented by the video signal output from the C-MOS sensor 44, a further 90° in the clockwise direction. The image obtained by this rotation processing (namely the front image) becomes an erect image.

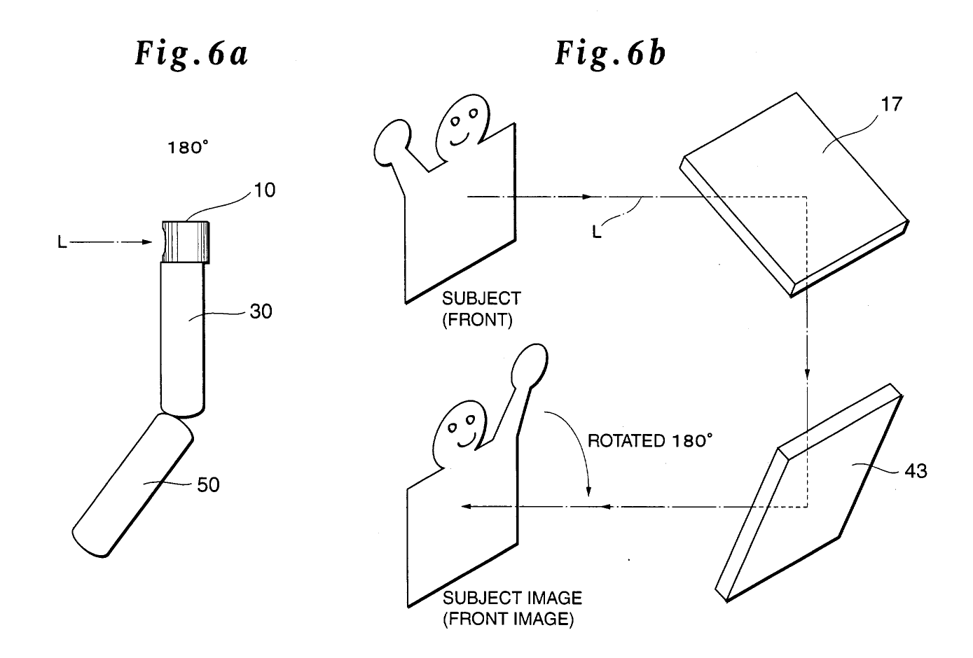

FIGS. 6a and 6b illustrate a case where the angle of rotation of the rotary body 10 is 180°.The front of the subject appears in FIG. 6b .

In a case where the angle of rotation is 180°, the image of an erect subject is that obtained by rotating the subject 180° owing to image formation by the lenses 13, 14, 15 and 16, reflection by the first mirror 17 and reflection by the second mirror 43. For this reason, image processing is executed so as to rotate the image, which is represented by the video signal output from the C-MOS sensor 44, by 180°. The image obtained by this rotation processing (namely the front image) becomes an erect image.

In the portable telephone 1 according to this embodiment, the angle of rotation of the rotary body 10 is detected and the image processing of the above-described types is executed in dependence upon the angle of rotation detected.

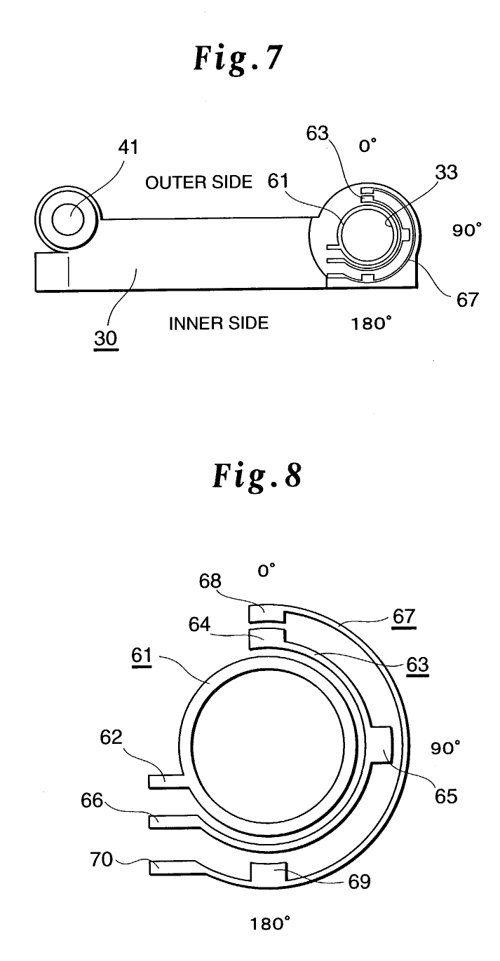

FIG. 7 is a plan view showing the portable telephone 1 when rotating body 10 has been removed from the first half body 30.

The top side of the cut-out 30A of first half body 30 is formed to have three metal terminals 61, 63 and 67.

FIG. 8 is an enlarged view of the metal terminals 61, 63 and 67.

The first metal terminal 61 is annularly shaped so as to surround the opening 33 of the cut-out 30A. The annular metal terminal 61 has one projecting end 62, which is connected to a ground line.

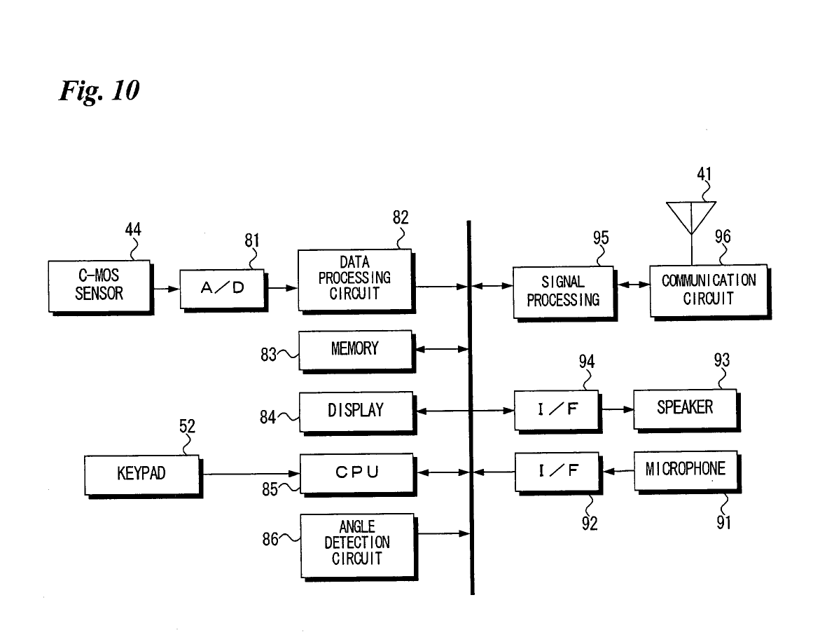

The second metal terminal 63 has a length of approximately ¾ of a full circle so as to surround the first metal terminal 61. A portion of the second metal terminal 63 outwardly of the first half body 30 (the direction that prevails when the rotary body 10 is situated at 0°) and a portion of the second metal terminal 63 to the right of the first half body 30 (the right side as seen from the user when the user holds the opened portable telephone 1, this being the direction that prevails when the rotary body 10 is situated at 90°) are formed to have contact portions 64, 65, respectively, the widths whereof are greater than the width of the remaining portion of the second metal terminal 63. The second metal terminal 63 has one projecting end 66. This end 66 is connected to an angle detection circuit 86 (see FIG. 10), described later. A predetermined voltage is applied to this end 66.

The third metal terminal 67 has a length of approximately ¾ of a full circle so as to further surround the second metal terminal 63. A portion of the third metal terminal 67 outwardly of the first half body 30 and a portion inwardly of the third metal terminal 67 inwardly of the first half body 30 (the direction that prevails when the rotary body 10 is situated at 180°) are formed to have contact portions 68, 69, respectively, the widths whereof are greater than the width of the remaining portion of the third metal terminal 67. The third metal terminal 67 has one projecting end 70. This end 70 also is connected to an angle detection circuit 86, described later. A predetermined voltage is applied to this end 70.

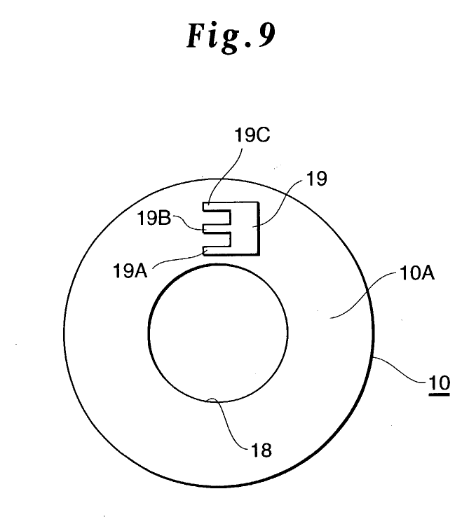

FIG. 9 is a bottom view of the rotary body 10. Such components as the second tubular portion 25 and imaging lens 16 are not shown in FIG. 9.

The rotary body 10 has a bottom surface 10A to which a metal piece 19 is fixed at a position corresponding to the lower side of the first opening 11. The metal piece 19 is formed to have three segments, namely a first segment 19A, second segment 19B and third segment 19C, which are mutually conductive and project in a downward direction.

When the rotary body 10 is at the 0° position, the second segment 19B contacts the contact portion 64 of the second metal terminal 63 and the third segment 19C contacts the contact portion 68 of the third metal terminal 67. Further, the first segment 19A contacts the first metal terminal 61. The third metal terminal 67 and the second metal terminal 63 are connected to the ground line.

When the rotary body 10 is at the 90° position, the first segment 19A contacts the first metal terminal 61 and the second segment 19B contacts the contact portion 65 of the second metal terminal 63. The third segment 19C, however, does not contact the third metal terminal 67. The second metal terminal 63 is connected to the ground line but the third metal terminal 67 is not.

When the rotary body 10 is at the 180° position, the first segment 19A contacts the contact portion 69 of first metal terminal 61 and the third segment 19C contacts the third metal terminal 67. The second segment 19B does not contact the second metal terminal 63.

The fact that the rotary body 10 is at the 0° position is ascertained by detecting that both the second and third metal terminals 63, 67 are connected to the ground line. The fact that the rotary body 10 is at the 90° position is ascertained by detecting that the second metal terminal 63 is connected to the ground line and that the third metal terminal 67 is not. The fact that the rotary body 10 is at the 180° position is ascertained by detecting that the third metal terminal 67 is connected to the ground line and that the second metal terminal 63 is not.

FIG. 10 is a block diagram illustrating the electrical structure of the portable telephone 1.

The overall operation of the portable telephone 1 is controlled by a CPU 85.

Voice that has entered from a microphone 91 is output as a voice signal from the microphone 91 and is input to a signal processing circuit 95 via an interface 92. The signal processing circuit 95 modulates the signal. The modulated signal is transmitted from the antenna 41 to another portable telephone by a communication circuit 96.

A voice signal received by the antenna 91 is input to the communication circuit 96. The voice signal is applied to the signal processing circuit 95 via the communication circuit 96 and is demodulated by the signal processing circuit 95. The demodulated voice signal is applied to a speaker 93 via an interface 94, whereby voice is output.

The portable telephone 1 includes a memory 83 for temporarily storing data, a display unit 84 and an angle detection circuit 86 for detecting the angle of rotation of the rotary body 10.

The angle detection circuit 86 is connected to the first metal terminal 61, second metal terminal 63 and third metal terminal 67 described above. Voltage is applied to the second metal terminal 63 and third metal terminal 67. The angle of rotation of the rotary body 10 is detected, in the manner described above, by detecting a fluctuation in the voltage applied to the second metal terminal 63 and third metal terminal 67. Data representing the detected angle of rotation is applied to a data processing circuit 82, described later, whereby the data is subjected to image rotation processing in accordance with the angle of rotation.

A signal indicating depression of a key on the numeric keypad, for example, is input to the CPU 85. A menu is displayed on the display screen 42 by pressing a menu button on the keypad. The imaging mode is selected when the image of a subject is to be sensed.

When the imaging mode is established, the image of the subject is sensed by the C-MOS sensor 44 and a video signal representing the image of the subject is output. The video signal is converted to digital image data by an analog/digital converter circuit 81. The digital image data obtained by the conversion is input to the data processing circuit 82.

In addition to executing predetermining data processing such as gamma correction and white balance adjustment, the data processing circuit 82 executes image rotation processing in accordance with the angle detected by the angle detection circuit 86 as set forth above. The image represented by image data output from the data processing circuit 82 becomes an erect image.

Image data output from the data processing circuit 82 is applied to the display unit 84 so that the image is displayed on the display screen 42.

When the imaging mode has been established, an ENTER button included in the keypad 52 becomes a shutter-release button. When the ENTER button is pressed, image data output from the data processing circuit 82 as mentioned above is stored temporarily in the memory 83.

If a transmit mode is set using the menu, image data that has been stored in the memory 83 is read out and applied to the antenna 41 via the signal processing circuit 95 and communication circuit 96. The image data is received and displayed by another portable telephone.

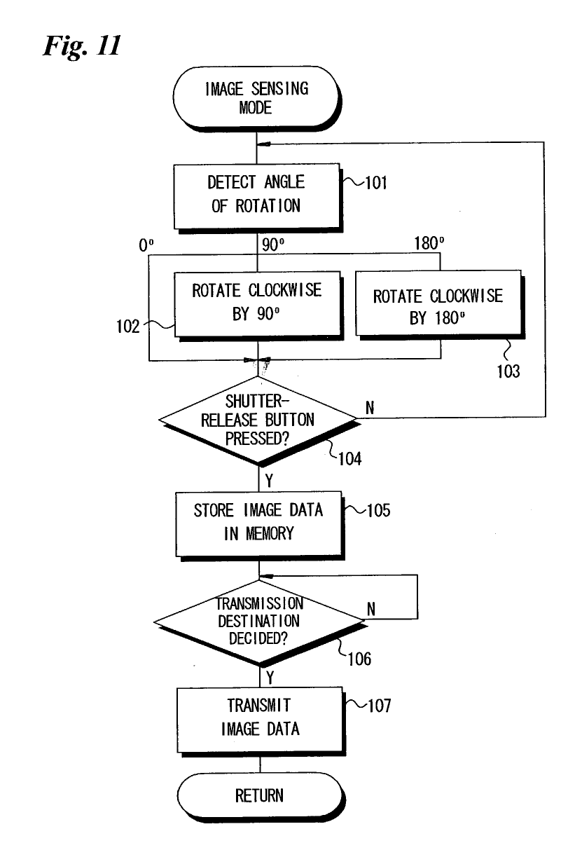

FIG. 11 is a flowchart illustrating processing in the imaging mode.

When the imaging mode is set, the image of a subject is sensed and image data representing the image of the subject is obtained. The angle of rotation of the rotary body 10 is detected in the manner described above (step 101). If the angle of rotation is 90°, processing for rotating the image 90° in the clockwise direction is executed in order to erect the image obtained (step 102). If the angle of rotation is 180°, processing for rotating the image 180° is executed in order to erect the image obtained (step 103). If the angle of rotation is 0°, then the image data obtained will represent an erect image and, hence, image rotation processing is not executed.

If the shutter-release button is pressed (“YES” at step 104), then image data (already subjected to rotation processing) obtained by imaging is stored temporarily in the memory 83 (step 105).

The portable telephone 1 is set to the transmit mode and the destination to which image data is to be transmitted is decided (“YES” at step 106). When this is done, the image data that has been stored temporarily in the memory 83 is transmitted to the transmit destination (step 107).

Since there is no cord disposed between the rotary body 10 and the first half body 30 of the portable telephone 1, the rotary body 10 is capable of being rotated in excess of 360°. Thus imaging can be performed in a desired direction while the portable telephone 1 is being held by the user. Since image rotation processing is executed, an erect image is obtained even in a case where the rotary body 10 has been rotated.

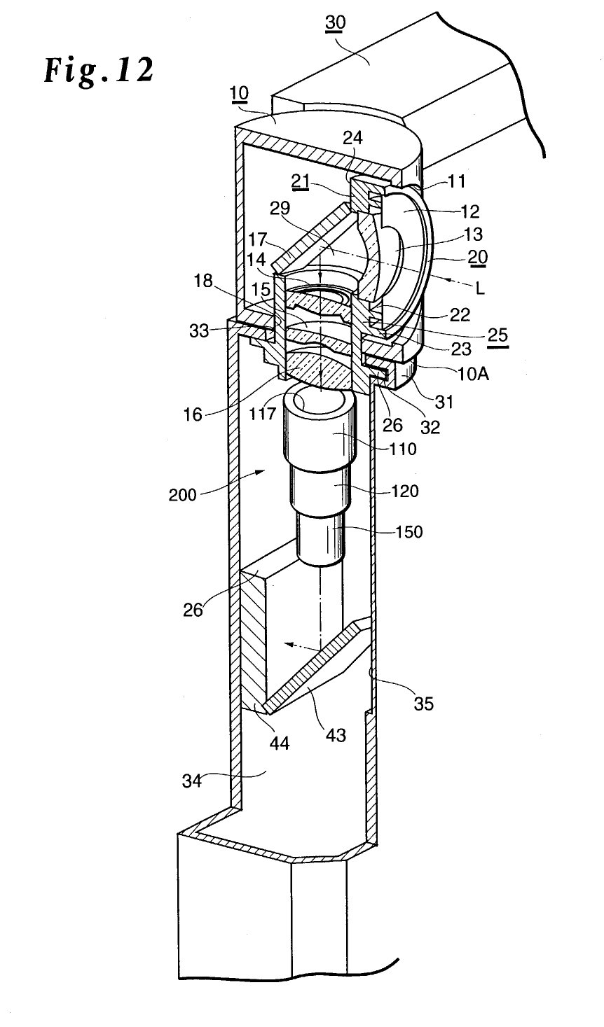

FIG. 12 is a partially cut-away view illustrating an arrangement in which a zoom lens mechanism 200 has been provided inside the first half body 30.

The zoom lens mechanism 200 is positioned in such a manner that its optic axis coincides with the optic axis of the lenses 14, 15 and 16 of the rotary body 10.

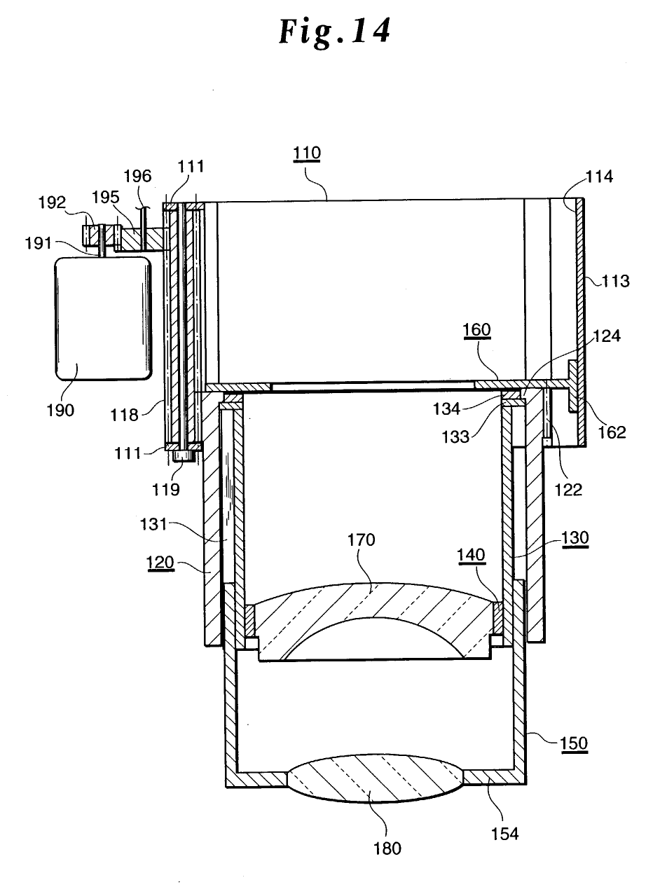

The zoom lens mechanism 200 has a fixed barrel 110, a first lens barrel 120 and a second lens barrel 150 secured to the inner wall 34 of the first half body 30. The first lens barrel 120 is held by the fixed barrel 110 so as to be freely insertable into and withdrawable from the fixed barrel 110. The second lens barrel 150 is held by the first lens barrel 120 so as to be freely insertable into and withdrawable from the first lens barrel 120. Extending the zoom lens mechanism 200 (the state shown in FIG. 12 and in FIG. 14 described later) establishes the telephoto state, and collapsing the zoom lens mechanism 200 to the maximum extent (in which state the first lens barrel 120 and second lens barrel 150 are received within the fixed barrel 110) establishes the wide-angle state. Since the zoom lens mechanism 200 and rotary body 10 are independent of each other, a zoom function can be achieved irrespective of rotation of the rotary body 10. Light that exits from the rotary body 10 enters the interior of the zoom lens mechanism 200 from an opening 117 in the first lens barrel 120.

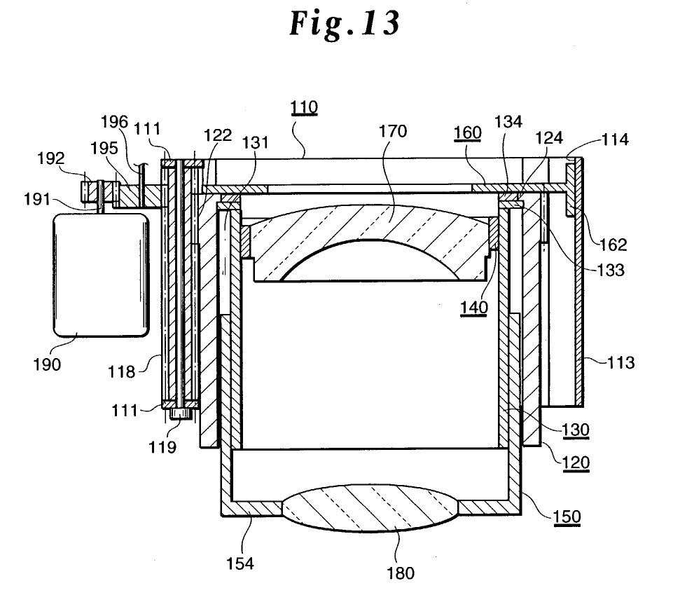

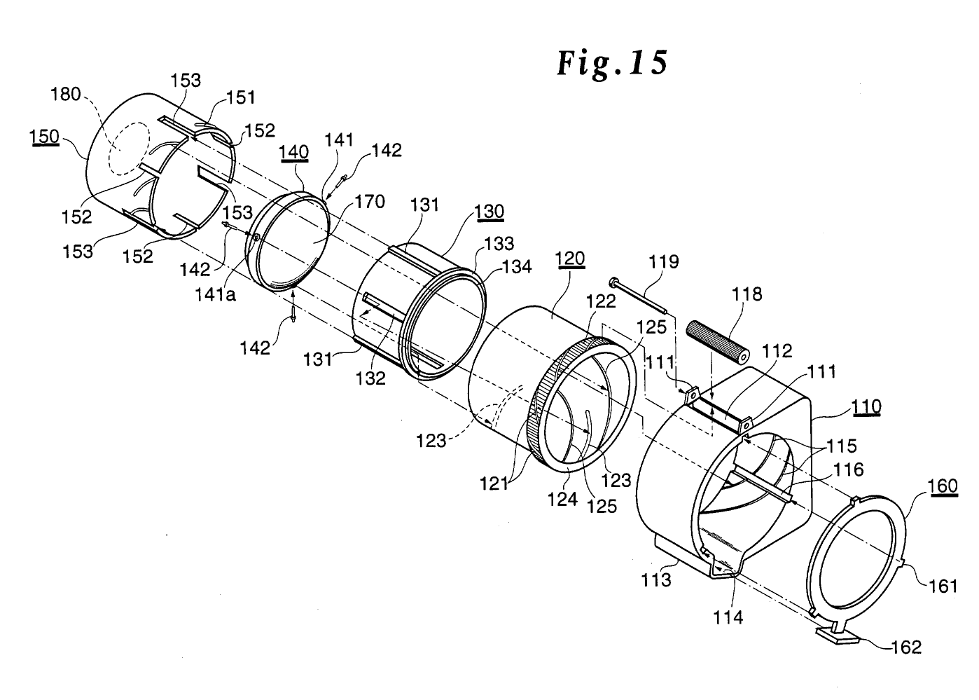

FIGS. 13 to 15 illustrate the zoom lens mechanism 200, in which FIG. 13 is a sectional view of the wide-angle state, FIG. 14 a sectional view of the telephoto state and FIG. 15 an exploded perspective view of the zoom lens mechanism 200.

The fixed barrel 110 is cylindrical in shape and the inner circumference thereof is substantially the same as the outer circumference of the first lens barrel 120.

A portion of the outer circumferential surface of the fixed barrel 110 is formed to have a longitudinal opening 112 extending in the axial direction. Both ends of the longitudinal opening 112 are formed to have bearings 111 along the end face of the fixed barrel 110. The bearings 111 are formed to have holes 111a through which a pin 119 is passed. More specifically, by passing the pin 119 through the holes 11a in the bearings 111, a flat gear 118 is held in freely reliable fashion by the pin 119. The flat gear 118 protrudes slightly into the interior of the fixed barrel 110.

The inner circumferential surface of the fixed barrel 110 is formed to have a plurality of protruding helicoid threads 115. The inner circumferential surface of the fixed barrel 110 is further formed to have three key grooves 116 in the axial direction at intervals of approximately 120°. The fixed barrel 110 is further formed to have a diametrically protruding portion 113 in the axial direction.

The first lens barrel 120 also is cylindrical in shape.

The outer circumferential surface of the first lens barrel 120 is formed to have a circumferentially extending driven gear 122 at one end thereof. The driven gear 122 meshes with the flat gear 118. The driven gear 122 is formed to have helicoid threads 121 for meshing with the helicoid threads 115 formed on the inner circumferential surface of the fixed barrel 110. The helicoid threads 121 are recessed.

The inner circumferential surface of the first lens barrel 120 also is formed to have a plurality of helicoid threads 125 and a plurality of cam grooves 123.

One end face of the first lens barrel 120 (the end face on the side visible in FIG. 15) defines a flange 124 the inner circumference of which is smaller than that of the first lens barrel 120.

The second lens barrel 150 also is circular in shape. The outer circumference of the second lens barrel 150 is approximately the same as the inner circumference of the first lens barrel 120. As mentioned above, the second lens barrel 150 is freely insertable into and withdrawable from the first lens barrel 120.

One end face of the second lens barrel 150 (the end whose opening is visible in FIG. 15) is formed to have a plurality of helicoid threads 151 on the outer circumferential surface thereof. This end face is formed to have three cam pin grooves 15 extending axially for receiving cam pins 142, described later.

The inner circumferential surface of the second lens barrel 150 is formed to have three linear grooves 153 extending in the axial direction.

The other end face of the second lens barrel 150 has a bent portion 154, namely a portion obtained by being bent inwardly (see FIGS. 13 and 14). A first lens 180 constituting the zoom lens is held by the bent portion 154.

The zoom lens mechanism 200 includes a rectilinear guide cylinder 130 in addition to the fixed barrel 110, first lens barrel 120 and second lens barrel 150. The rectilinear guide cylinder 130 also is substantially cylindrical in shape. The outer circumference of the rectilinear guide cylinder 130 is approximately the same as the inner circumference of the second lens barrel 150. The rectilinear guide cylinder 130 is free to move back and forth within the second lens barrel 150.

The outer circumferential surface of the rectilinear guide cylinder 130 is formed to have a plurality of axially extending projections 131. The latter are received by the linear grooves 153 of the second lens barrel 150 by inserting the rectilinear guide cylinder 130 into the second lens barrel 150. The rectilinear guide cylinder 130 and second lens barrel 150 move rectilinearly relative to each other in the axial direction.

A first flange 133 having an inner circumference substantially the same as that of the rectilinear guide cylinder 130 is attached to the end face of the rectilinear guide cylinder 130 (the end face on the side visible in FIG. 15). A second flange 134 is attached to the outside of the first flange 133. The second flange 134 has an inner circumference substantially the same as that of the first flange 133 and an outer circumference smaller than that of the first flange 133.

The zoom lens mechanism 200 includes a lens holding frame 140 for holding a second lens 170 (see FIGS. 13 and 14).

The outer circumference of the lens holding frame 140 is substantially the same as the inner circumference of the rectilinear guide cylinder 130.

The outer circumferential surface of the lens holding frame 140 is formed to have three slide projections 141 in each of which a hole 141a is formed to receive cam pins 142. When the lens holding frame 140 is inserted into the rectilinear guide cylinder 130 and the slide projections 141 are received by the linear grooves 132 of the rectilinear guide cylinder 130, the lens holding frame 140 is free to move axially within the rectilinear guide cylinder 130.

When the cam pins 142 are inserted into the projections 141 with the lens holding frame 140 inserted into the rectilinear guide cylinder 130, the cam pins 142 are received by the cam grooves 123, which are formed in the first lens barrel 120, by inserting the rectilinear guide cylinder 130 into the first lens barrel 120.

The zoom lens mechanism 200 includes a lens-barrel holding plate 160.

The lens-barrel holding plate 160 is a cylindrically shaped frame and is formed to have three outwardly protruding projections 161. The inner circumference of the lens-barrel holding plate 160 is smaller than that of the rectilinear guide cylinder 130. The outer circumference of the lens-barrel holding plate 160 is approximately the same as that of the first lens barrel 120 but is smaller than the outer circumference of the driven gear 122.

The outer side of the lens-barrel holding plate 160 is formed to have a segment brush 162.

When the rectilinear guide cylinder 130 is accommodated within the first lens barrel 120, the surface on the inner side of the flange 124 of the first lens barrel 120 contacts the surface of the first flange 133 because the first flange 133 of rectilinear guide cylinder 130 is larger than the second flange 134. The lens-barrel holding plate 160 is attached to the surface of the second flange 134 of the rectilinear guide cylinder 130 with the surface of the first flange 133 of rectilinear guide cylinder 130 in contact with the surface of flange 124 of first lens barrel 120. As a result, the flange 124 of the first lens barrel 120 is embraced by the first flange 133 of the rectilinear guide cylinder 130 and the lens-barrel holding plate 160. The first lens barrel 120 is held in freely rotatable fashion by the rectilinear guide cylinder 130 and lens-barrel holding plate 160.

The lens holding frame 140 is fitted into the rectilinear guide cylinder 130, and the rectilinear guide cylinder 130 is fitted into the second lens barrel 150. The second lens barrel 150 is fitted into the-first lens barrel 120, and the latter is fitted into the fixed barrel 110. Under these conditions, the flat gear 118 is mounted in the bearings 111 by the pin 119.

The zoom lens mechanism 200 includes a motor 190, which has a shaft 191 to which a gear 192 is attached. An idle gear 195 attached to a shaft 196 is provided between the gear 192 and flat gear 118. The motor 190 is secured to the inner wall of the first half body 30. Further, the shaft 196 is mounted within the first half body 30 in freely rotatable fashion.

If the rotating force of the motor 190 is transferred to the flat gear 118 via the idle gear 195 when the zoom lens mechanism 200 is in the wide-angle state, as shown in FIG. 13, the driving force of the flat gear 118 is transferred to the driven gear 122 of first lens barrel 120. When the driving force is transferred to the driven gear 122, the first lens barrel 120 moves axially away from the fixed barrel 110 while rotating because the helicoid threads 115 of the fixed barrel 110 are mating with the helicoid threads 121 of the first lens barrel 120.

When the first lens barrel 120 moves in the axial direction, the rectilinear guide cylinder 130 and lens-barrel holding plate 160 also move axially because the flange 124 of the first lens barrel 120 is being embraced by the first flange 133 of the rectilinear guide cylinder 130 and the lens-barrel holding plate 160. As a result, the segment brush 162 formed on the lens-barrel holding plate 160 moves along a slide portion 114 within the protruding portion 113 formed in the fixed barrel 110. Further, the projections 161 formed on the lens-barrel holding plate 160 move along the key grooves 116 formed on the inner circumferential surface of the fixed barrel 110.

Further, the first lens barrel 120 travels in the axial direction while rotating. The lens holding frame 140, therefore, in which the cam pins 142 are received in the cam grooves 123 formed in the inner circumferential surface of the first lens barrel 120, attempts to rotate. However, rotation is limited because the projections 141 of the lens holding frame 140 are inserted into the linear grooves 132 of the rectilinear guide cylinder 130. As a result, the lens holding frame 140 also travels in the axial direction in accordance with the cam grooves 123 of the first lens barrel 120.

Rotation of the second lens barrel 150 is limited because the linear projections 131 formed on the outer circumferential surface of the rectilinear guide cylinder 130 are received in the linear grooves 153 formed in the inner circumferential surface of the second lens barrel 150. Further, because the helicoid threads 151 formed in the outer circumferential surface of the second lens barrel 150 are received in the helical threads 125 formed in the inner circumferential surface of the first lens barrel 120, the second lens barrel 150 travels in the axial direction away from the first lens barrel 120 in accordance with the helical threads 125.

The helicoid threads 125 and cam grooves 123 are formed in such a manner that the amount of rotation of the lens holding frame 140, which travels in accordance with the cam grooves 123 formed in the first lens barrel 120, is greater than the amount of movement of the second lens barrel 150 that travels in accordance with the helicoid threads 125 formed in the first lens barrel 120. Accordingly, the spacing between the first lens 180 and second lens 170 is smaller in the telephoto state shown in FIG. 14 than the space between these lenses in the wide-angle state shown in FIG. 13. As a consequence, the telephoto and wide-angle states can be switched between in dependence upon the expansion and contraction of the length of zoom lens mechanism 200.

By virtue of the above-described operation, the state of the zoom lens mechanism 200 changes from the wide-angle state shown in FIG. 13 to the telephoto state shown in FIG. 14. It should be obvious that the operation for restoring the zoom lens mechanism 200 from the state shown in FIG. 14 to the state shown in FIG. 13 is the reverse of that described above.

In this embodiment, the angle of rotation of the rotary body 10 is detected in increments of 90°, as described above. It is required, therefore, that the aspect ratio of the image obtained not change even when the rotary body 10 is rotated 90°. Accordingly, if the imaging area of the C-MOS sensor 44 used in the portable telephone 1 of this embodiment is rectangular, then a square area at the central portion of this imaging area would be used for imaging.

Though the angle of rotation of the rotary body 10 is detected in increments of 90° in the above-described embodiment, it may be so arranged that this is detected in increments of 45°. If detection is performed in increments of 45°, the image would be generated using a video signal obtained from an area that is the result of rotating the square area, which is located in the imaging area of the C-MOS sensor 44, through an angle of 45°. Thus, if detection is performed in increments of 45°, the proportion of the imaging area not used increases. This means that a C-MOS sensor having a greater number of pixels would be utilized.

As many apparently widely different embodiments of the present invention can be made without departing from the spirit and scope thereof, it is to be understood that the invention is not limited to the specific embodiments thereof except as defined in the appended claims.

What is claimed is:

1. A portable telephone equipped with an image sensing unit, comprising a portable telephone main unit and a columnar body;
said columnar body being freely rotatable with respect to said portable telephone main unit and having a hollow interior, a side face formed to include an entrant-light opening for introducing light and a bottom face formed to include an emergent-light opening for emitting light, a first deflector for guiding light, which has entered from the entrant-light opening, to the emergent-light opening being disposed within said columnar body; and
said portable telephone main unit including:
a solid-state electronic image sensing device disposed at a position, which is independent of said columnar body, on an optical path of emergent light from the emergent-light opening, for outputting a video signal representing the image of a subject that has been formed on a photoreceptor surface; and
a transmitting circuit for transmitting the video signal, which has been output from said solid-state electronic image sensing device, to a telephone network.

2. The portable telephone according to claim 1, wherein said solid-state image sensing device is placed so as to lie parallel to a surface of said portable telephone main unit on the inner side thereof;
said portable telephone main unit further including a second deflector for guiding the emergent light to the photoreceptor surface of said solid-state image sensing device.

3. The portable telephone according to claim 1, further comprising:
a detector for detecting angle of rotation of said columnar body;
a display unit for displaying the image of a subject, which is represented by a video signal output from said solid-state image sensing device, on a display screen; and
a display controller for controlling said display unit, in accordance with the angle detected by said detector, in such a manner that the image of the subject to be displayed will be displayed as an erect image.

4. A columnar body mounted freely rotatably on an image sensing unit main body, said columnar body having a hollow interior, a side face formed to include an entrant-light opening for introducing light and a bottom face formed to include an emergent-light opening for emitting light;
a first deflector for guiding light, which has entered from the entrant-light opening, to the emergent-light opening being disposed within said columnar body.

5. An image sensing unit comprising an image sensing unit main body and a columnar body;
said columnar body being freely rotatable with respect to said image sensing main body and having a hollow interior, a side face formed to include an entrant-light opening for introducing light and a bottom face formed to include an emergent-light opening for emitting light, a first deflector for guiding light, which has entered from the entrant-light opening, to the emergent-light opening being disposed within said columnar body; and
said image sensing unit main body including a solid-state electronic image sensing device disposed at a position, which is independent of said columnar body, on an optical path of emergent light from the emergent-light opening, for outputting a video signal representing the image of a subject that has been formed on a photoreceptor surface.

6. A digital camera comprising a digital camera main unit and a columnar body;
said columnar body being freely rotatable with respect to said digital camera main unit and having a hollow interior, a side face formed to include an entrant-light opening for introducing light and a bottom face formed to include an emergent-light opening for emitting light, a first deflector for guiding light, which has entered from the entrant-light opening, to the emergent-light opening being disposed within said columnar body; and
said digital camera main unit including:
a solid-state electronic image sensing device disposed at a position, which is independent of said columnar body, on an optical path of emergent light from the emergent-light opening, for outputting a video signal representing the image of a subject that has been formed on a photoreceptor surface; and
recording controller for recording the video signal, which has been output from said solid-state electronic image sensing device, on a recording medium.

7. A method of controlling a portable telephone equipped with an image sensing unit and having a portable telephone main unit and a columnar body, the columnar body being freely rotatable with respect to the portable telephone main unit and having a hollow interior, a side face formed to include an entrant-light opening for introducing light and a bottom face formed to include an emergent-light opening for emitting light, said method comprising the steps of:
guiding light, which has entered from the entrant-light opening, to the emergent-light opening;
disposing a solid-state electronic image sensing device at a position, which is independent of the columnar body, in the portable telephone main unit on an optical path of emergent light from the emergent-light opening;
outputting a video signal representing the image of a subject that has been formed on a photoreceptor surface; and
transmitting the video signal, which has been output from the solid-state electronic image sensing device, to a telephone network.

8. A method of controlling an image sensing unit in a portable telephone equipped with the image sensing unit and having a portable telephone main unit and a columnar body, the columnar body being freely rotatable with respect to the portable telephone main unit and having a hollow interior, a side face formed to include an entrant-light opening for introducing light and a bottom face formed to include an emergent-light opening for emitting light, said method comprising the steps of:
guiding light, which has entered from the entrant-light opening, to the emergent-light opening;
disposing a solid-state electronic image sensing device at a position, which is independent of the columnar body, in the portable telephone main unit on an optical path of emergent light from the emergent-light opening; and
outputting a video signal representing the image of a subject that has been formed on a photoreceptor surface.

9. A method of controlling a digital camera having a digital camera main unit and a columnar body, said columnar body being freely rotatable with respect to said digital camera main unit and having a hollow interior, a side face formed to include an entrant-light opening for introducing light and a bottom face formed to include an emergent-light opening for emitting light, said method comprising the steps of:
guiding light, which has entered from the entrant-light opening, to the emergent-light opening;
disposing a solid-state electronic image sensing device at a position, which is independent of the columnar body, in the digital camera main unit on an optical path of emergent light from the emergent-light opening;
outputting a video signal representing the image of a subject that has been formed on a photoreceptor surface; and
recording the video signal, which has been output from the solid-state electronic image sensing device, on a recording medium.
